(19) United States
(12) Patent Application Publication
(10) Pub. No.: US 2017/0355168 A1
(43) Pub. Date: Dec. 14, 2017

(54) Liquid polymer sprayed sheet with fused layers and variable ratio of polymers droplets and entrapped bubbles

(71) Applicant: Tamicare Ltd., Heywood (GB)

(72) Inventors: Ehud Giloh, Heywood (GB); Tamar Giloh, Heywood (GB)

(21) Appl. No.: 15/617,101

(22) Filed: Jun. 8, 2017

Related U.S. Application Data
(60) Provisional application No. 62/347,138, filed on Jun. 8, 2016.

(51) Int. Cl. B32B 3/26; B05D 1/02

(52) U.S. Cl. CPC B32B 3/26; B05D 1/02; B32B 2250/24; B32B 2307/722

(57) ABSTRACT

A sheet is provided, the sheet including at least two polymeric layers including a bottom layer and a top layer, wherein the at least two polymeric layers are sprayed, wherein the at least two polymeric layers are seamlessly fused across the entire area of the sheet, creating a seamless, one piece sheet, and wherein at least one polymeric layer of the sheet contains gas bubbles. An article including the sheet is also provided.

### CROSS-REFERENCE TO RELATED APPLICATIONS

This application claims the benefit of and incorporates by reference the content of U.S. Provisional Pat. App. No. 62/347,138, filed Jun. 8, 2016.

### BACKGROUND

In an additive manufacturing process, it is desired to achieve specific product features; this can be achieved when precise process control is exerted over the process, allowing adjustment of the structure of an interface between the layers as well as the layers' structure. This disclosure describes a novel product which is made by spraying polymers in a liquid according to a unique process which enables control of the layers' structure and features, not yet achieved in textile related products.

### SUMMARY

The present application relates to a polymeric based product, article or sheet, comprised of at least two sprayed polymeric layers, a bottom layer and a top layer, the liquid polymer being sprayed on top of a temporarily support surface, such as a mold surface, or a conveyor belt surface. The article character is defined and adjusted by controlling the ratio between the polymer droplets and bubbles trapped within each of the at least two layers, as well as the characteristics of the fusion between the at least two layers of sprayed polymer/s.

In addition to the polymeric structures, different textile fibers and other particles and additives can be added into or onto the polymeric structure, so that a variety of textile-like products are achieved.

In one aspect, the present disclosure provides a sheet having at least two polymeric layers, a bottom layer and a top layer, wherein the at least two polymeric layers are sprayed, the at least two polymeric layers are seamlessly fused across the entire area of the sheet, creating a seamless, one piece sheet, and at least one polymeric layer of the sheet contains gas bubbles.

In another embodiment, a first ratio between a volume of a polymer in a first one of the layers and a volume of gas bubbles in the first layer differs from a second ratio between a volume of a polymer in a second one of the layers and a volume of gas bubbles in the second layer. In such an embodiment, the first ratio may be such that the first layer contains between 100% polymer and 0% gas bubbles and 5% polymer and 95% gas bubbles.

In an embodiment, more than half of the gas bubbles in a first layer of the sheet are of closed shape, isolated from each other. That is, more than half of the gas bubbles may be fully embedded within the sheet, without gas communication with other gas bubbles in the sheet.

In another embodiment, more than half of the gas bubbles in a first layer of the sheet are of open shape, allowing air passage between the gas bubbles of open shape. That is, more than half of the gas bubbles may be at least partially exposed to an environment of the sheet, such that gas communication exists between the gas bubbles and the environment and/or between different gas bubbles of the sheet.

In an embodiment, the sheet comprises more than two polymeric layers, wherein each polymeric layer differs with respect to at least one of a ratio of polymer to gas bubble volume or a characteristic size of gas bubbles contained within the layers.

In an embodiment, at least one of the gas bubbles contains a gas other than air.

In an embodiment, at least one of loose fibers or loose particles are embedded within the sheet such that the loose fibers or loose particles are fully submerged in the sheet.

In an embodiment, at least one of loose fibers or loose particles are embedded within an outer part of the sheet such that the loose fibers or loose particles are affixed to the outer part of the sheet and partially protruding out of the sheet.

In an embodiment, at least one of loose fibers or loose particles are embedded within the sheet between specific polymeric layers of the sheet.

In another aspect, the present disclosure provides an article comprising a sheet of material as described herein.

In an embodiment, the article is one of a shoe upper, a sole, an insole, a bra, a part of a garment, an automotive interior component, or a car door panel.

### BRIEF DESCRIPTION OF THE DRAWINGS

FIG. 1 shows a side view of an article having four layers, each layer is characterized by different ratio of polymer to bubbles and different bubbles size.

FIG. 2A shows a top view of an article having three zones, side by side, each zone is of different construction.

FIG. 2B shows a side cross-sectional view of the article shown in FIG. 2A.

FIG. 3 shows a section of two polymer layers with a fused zone connecting the two polymeric layers.

### DETAILED DESCRIPTION

The present disclosure relates to a polymeric based article or sheet, said article or sheet being comprised of at least two or more sprayed polymeric layers. A liquid polymer can be sprayed on top of a surface such as mold surface, or a conveyor belt surface when said surface serves as a temporary basis for the creation of the article, and the article, after being cured, is removed from said surface.

The liquid polymer can be a waterborne polymer, in a form of suspension, solution, dispersion, and the like. The polymer can comprise natural or synthetic polymers. A natural polymer includes, without limitation, latex rubber. A synthetic polymer includes, without limitation, polyurethane. For spraying purposes, emulsions, dispersions, suspensions, or solutions of the polymer, e.g., liquid Polyurethane dispersion (PUD) are generally used. After spraying the polymer material, with or without additional process steps, the sprayed polymer layer may be allowed to partially or completely dry or cure before the next layer is applied. The drying process may include curing or setting processes, depending on the choice of polymer. For example, when latex rubber is used as the product material, the latex rubber would cure as it dries. In some embodiments, a second polymer may be sprayed onto the first polymer layer while it is dry, semi dry, wet, e.g., partly cured or uncured.

The article character is affected by the characteristics of the fusion zone between the at least two layers of sprayed polymer. By controlling the wetness/dryness of the first sprayed layer prior to the application of the second sprayed layer, the physical pattern of the interface, including the depth of fusion between the at least two layers as determined by the thickness of the fused zone created by the process. An amalgamed polymeric area is created, in which each layer is mixed into the other to a certain extent. This can result in an ultimate bonding between two different polymers, while preventing delamination, as well as allowing mixtures of different types of polymers which usually can't be mixed. Such a bonding may result in a seamless fusion of neighboring layers of the material. That is, polymer composition, density, degree of crosslinking, number or type of includes bubbles or other included volumes of gas, number or type of embedded fibers or other particles, or other properties of the multi-layered material may change continuously from one layer to the next such that there is no discrete boundary between neighboring layers. A region of continuous transition between such neighboring layers may be characterized as a fusion layer via which the two neighboring layers of the material are fused together or otherwise adhered to each other seamlessly fused together.

The sheet or product as mentioned above contains air or gas bubbles. The amount of bubbles in a given volume of polymeric layer is controllable, resulting in a sheet containing a certain, controllable amount of polymeric material and a certain, controllable amount of bubbles in a given volume.

The amount of air or any other gas bubbles within each polymeric layer can be actively adjusted. For instance, by stirring or otherwise agitating the liquid polymer so that air bubbles are created and trapped in the liquid, before spraying so to entrap air into it. Alternatively, adding gas bubbles may be performed by adding a suitable blowing agent such as sodium hydrogen carbonate or liquid carbon dioxide. Reducing the amount of gas bubbles may be performed by adding a suitable defoaming agent such as silicones, glycols or alcohols, into the liquid polymer either before or immediately after the spraying, or by any other suitable conventional method to create an article or a sheet with precisely adjusted polymer to bubbles ratio (porosity). For example, a defoaming agent or a blowing agent can be used to hinder or promote the creation of bubbles entrapped within the layer.

In addition to the ability to use different polymers in a liquid, each having its own characteristics, the structure of the polymeric based article or sheet can be defined and controlled by modifying and or increasing/decreasing at least one of the following variables:

(i) the amount of closed air bubbles entrapped between the sprayed polymer droplets, can be controlled, for example, by the type of the polymer, ratios of different polymers, or by adjusting its formula;

(ii) the amount of semi-closed air bubbles entrapped between the sprayed polymer droplets, can be controlled, for example, by the type of the polymer, by adjusting the ratio of different polymers, or by adjusting its formula;

(iii) the amount of air passageways or channels created between the at least two sheet's surfaces can be controlled, for example, by the type of the polymer, or by adjusting its formula;

(iv) environmental conditions, air temperature and humidity, at the spraying area;

(v) temperature of the mold surface during the process;

(vi) time between the at least two sequential liquid polymer spray sessions;

(vii) curing temperature, duration and intensity (temperature curve−rise/drop versus time) for each layer;

(viii) the structure of the interface between the at least first layer and second layer droplets may be controlled, for example, by controlling the level of curing, cross linking and or wetness of the first polymeric layer droplets at the time of spraying the second polymeric layer; thus allowing droplets of the two layers to merge to a desired level (amount of mixed polymers of the two sequential layer in a given volume) in a controllable manner; so to create the desired continues, fused layers thickness in the vertical dimension;

(ix) liquid polymer droplets size, which may be controlled, for example, by the gas pressure applied on the polymer, the gas velocity, or the viscosity of the liquid;

(x) liquid polymer solid content, which may be controlled for example by adding or removing solvent such as water, to or from the liquid polymer;

(xi) liquid polymer viscosity, can be controlled, for example by adding thickening agent, or by diluting the polymer with solvent such as water; and

(xii) liquid polymer surface tension can be controlled, for example, by adding surfactant.

The resulting article characteristics can vary in the following aspects, strength, stretchability, softness, hand-feel, drape and weight (or density) between the different layers such as the inner layers or the different outer layers (the surfaces) of the sheet (the bottom layer or the top layer). For example, one surface may be soft and spongy while the other surface can be rigid and sealed. Microscopic examination of the article can show the construction difference between the layers, the fusion intensity or level as defined by the number of droplets of the two sprayed layers which are merged together versus the number of droplets which are not merged in a given area, the different polymer to bubble ratio (density) which may vary in the range of between about 100% polymer and 0% air bubbles (or virtually zero bubbles) and 5% polymer and 95% air bubbles and the like, confirming that the desired product was produced via a continuous manufacturing process.

In one embodiment of the disclosure, a continuous polymeric sheet article is provided. The sheet can be built-up from at least two sprayed layers of liquid polymer, and is structured as a network of at least partly interconnected (dry) droplets, organized in a three dimensional space, to create a polymeric layer having no bubbles, entrapped closed bubbles, entrapped opened bubbles, or a combination thereof so to create the desired continuous structure of layers that are entirely fused in the vertical dimension.

In one aspect, the at least two fused sprayed layers are distinguished from each other by at least one physical characteristic—the ratio between the polymer and the bubbles, which can vary in the range of 100% polymer and 0% bubbles and up to 5% polymer and 95% bubbles, according to the pre-determined desired characteristics of the article. In addition, other aspects such as polymer droplet size or chemical composition (e.g., one layer composition can be a polyurethane dispersion (PUD) and another layer composition can be natural rubber latex) can be predetermined, thus providing a hybrid polymeric sheet comprising at least two different characteristics in the same continuous polymeric sheet.

In another aspect, the intensity or level of fusion as determined by the physical pattern or the interface shape as defined by the number and shape on any merged droplet, depth of fused zone (which can be visually observed microscopically) between the layers can affect the characteristics of the sheet. For example, the lower the fusion intensity or level between the layers, the higher the probability of delamination, which is undesirable. The fusion intensity or level should be such that the at least two layers are seamlessly fused.

In another aspect, the article can be permeable to air or gas, the air permeability can be created by continuous passageways between the outer surfaces open pores, allowing air/gas passage from one surface to the other surface of the article, via the at least two different layers' bubbles.

In another aspect, at least one of the layers can have a polymer/bubble ratio range of nearly 100% polymer and 0% bubbles (or virtually zero bubbles), creating an external, or internal sealed (no bubbles or virtually no bubbles) layer, to nearly 5% polymer to 95% bubbles. The percentage of polymer and bubbles can be determined by terms of volume, weight, or density. As bubble weight is practically zero, density (weight/cubic Cm) can be used for measuring the polymer to bubble ratio.

In another aspect, loose fibers or other particles, such as but not limited to textile fibers (e.g., viscose, polyamide, cotton or polyester fibers) or any other fibers, flacks, or powder of any material can be affixed to or embedded into the article. For example leather, glass, aluminum, magnetic metal or other metal powders or particles may be embedded or fused into the article by any means, such as electrostatic flocking, pneumatic flocking, powdering, or a combination thereof. The loose particles or fibers may be applied such that one end of the fibers is anchored and affixed to a polymeric layer and the other end is exposed, or such that the entire fiber or particle is fully submerged in the polymeric layer. The fibers can be affixed to at least one surface of the article, between sprayed layers, embedded within several or within all sprayed layers of an article, or any combination thereof. Representative examples of loose fibers and methods for their application are described in Tamicare's U.S. Patent publication no. 2012/0322333; U.S. Pat. No. 7,767,133; U.S. Pat. Nos. 7,901,740; 8,323,764; U.S. Pat. Nos. 9,480,829; and 8,840,969, which are all incorporated by reference in their entirety.

In another aspect, the thickness of the article can be in the range of 0.05 mm to 10 mm.

In yet another aspect, the thickness of the article can be in the range of 0.2 mm to 3 mm.

In a representative example, an article of a multi-layered material as described herein may be manufactured by sequentially spraying four a plurality of layers of liquid polymer, one on top of the other, in order to form a respective plurality of layers of a multi-layered material as described herein.

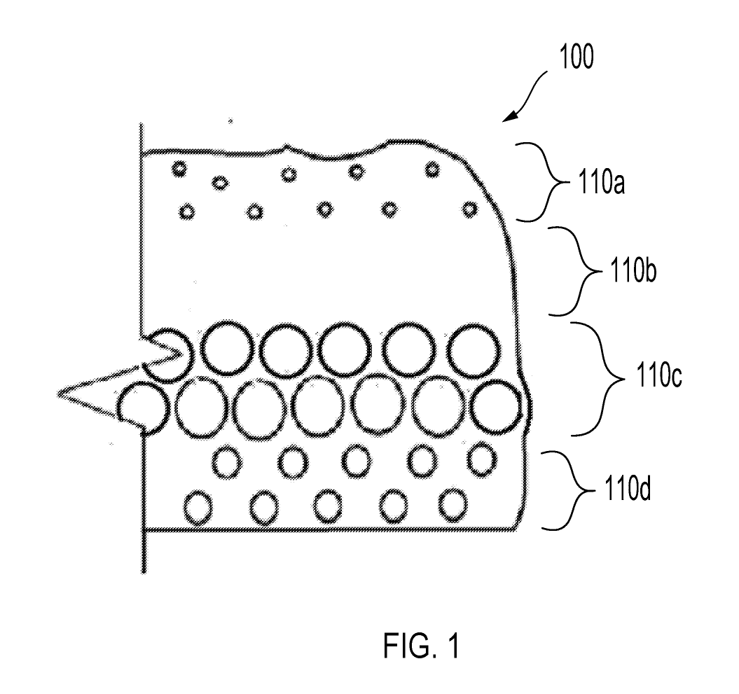

FIG. 1 shows a cross-sectional side view of such an article 100 having four layers 110a, 110b, 110c, and 110d. Each layer of the article 100 is characterized by different ratio of polymer to bubbles and a different bubble size. In some examples, one or more of the layers of such a multi-layered material could include no bubbles, or substantially no bubbles. For example, layer 110b of the material 100 illustrated in FIG. 1 has no bubbles, while other layers 110a, 110c, 110d of the material include bubbles.

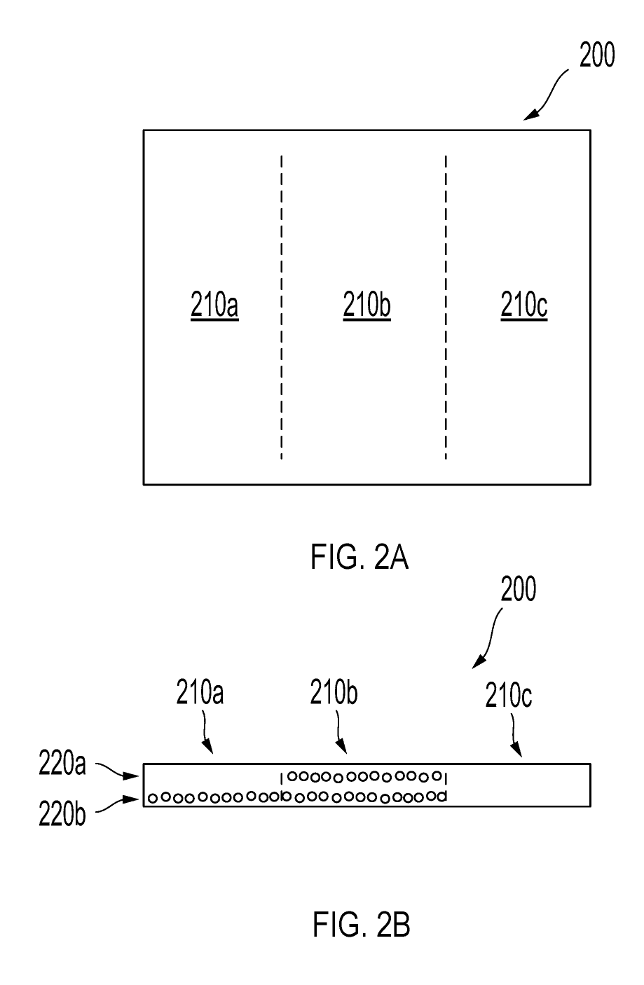

In another embodiment, an article of a multi-layered material as described herein may include different structures according to different regions of the article, side by side, in the horizontal dimension as shown in FIGS. 2A and 2B. FIG. 2A shows a top view of an article 200 having three regions, 210a, 210b, and 210c, side by side, each region having a respective different construction. FIG. 2B shows a cross-sectional side view of the article 200 showing that the article 200 includes two layers, 220a and 220b, for each region. The composition and structure of each of the layers 220a, 220b varies according to region 210a, 210b, 210c.

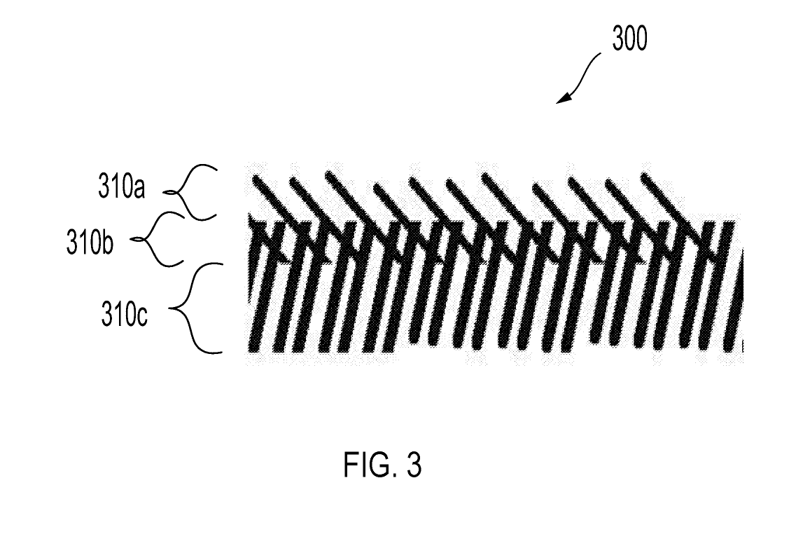

FIG. 3 shows a cross-sectional side view of an article 300 showing that the article 300 includes a first layer 310a composed of a first polymer composition and/or having a first gas bubble content and a second layer 310c composed of a second polymer composition and/or having a second gas bubble content. The layers 310a, 310c are fused together via a fusion layer 310b which has a polymer composition and/or a gas bubble content that is a combination or average of the polymer composition and/or gas bubble content of the first layer 310a and the second layer 310c.

In any of the previous embodiments, the article may have different levels of flexibility, stretchability, and/or rigidity.

While various aspects and embodiments have been disclosed herein, other aspects and embodiments will be apparent to those skilled in the art. All embodiments within and between different aspects of the invention can be combined unless the context clearly dictates otherwise.

The various aspects and embodiments disclosed herein are for purposes of illustration and are not intended to be limiting, with the true scope and spirit being indicated by the following claims.

1. A sheet comprising at least two polymeric layers comprising a bottom layer and a top layer, wherein the at least two polymeric layers are sprayed, wherein the at least two polymeric layers are seamlessly fused across the entire area of the sheet, creating a seamless, one piece sheet, and wherein at least one polymeric layer of said sheet contains gas bubbles.

2. The sheet of claim 1, wherein a first ratio between a volume of a polymer in a first one of the layers and a volume of gas bubbles in the first layer differs from a second ratio between a volume of a polymer in a second one of the layers and a volume of gas bubbles in the second layer.

3. The sheet of claim 2, wherein the first ratio is such that the first layer contains between 100% polymer and 0% gas bubbles and 5% polymer and 95% gas bubbles.

4. The sheet of claim 1, wherein more than half of the gas bubbles in a first layer of the sheet are of closed shape, isolated from each other.

5. The sheet of claim 1, wherein more than half of the gas bubbles in a first layer of the sheet are of open shape, allowing air passage between the gas bubbles of open shape.

6. The sheet of claim 1, wherein the sheet comprises more than two polymeric layers, wherein each polymeric layer differs with respect to at least one of a ratio of polymer to gas bubble volume or a characteristic size of gas bubbles contained within the layers.

7. The sheet of claim 1, wherein at least one of the gas bubbles contains a gas other than air.

8. The sheet of claim 1, wherein at least one of loose fibers or loose particles are embedded within the sheet such that the loose fibers or loose particles are fully submerged in the sheet.

9. The sheet of claim 1, wherein at least one of loose fibers or loose particles are embedded within an outer part of the sheet such that the loose fibers or loose particles are affixed to the outer part of the sheet and partially protruding out of the sheet.

10. The sheet of claim 1, wherein at least one of loose fibers or loose particles are embedded within the sheet between specific polymeric layers of the sheet.

11. An article comprising the sheet of material of claim 1.

12. The article of claim 11, wherein the article is one of a shoe upper, a sole, an insole, a bra, a garment, a part of a garment, or an automotive interior component.

13. The article of claim 11, wherein a first ratio between a volume of a polymer in a first one of the layers of the sheet and a volume of gas bubbles in the first layer differs from a second ratio between a volume of a polymer in a second one of the layers of the sheet and a volume of gas bubbles in the second layer.

14. The article of claim 13, wherein the first ratio is such that the first layer contains between 100% polymer and 0% gas bubbles and 5% polymer and 95% gas bubbles.

15. The article of claim 11, wherein more than half of the gas bubbles in a first layer of the sheet are of closed shape, isolated from each other.

16. The article of claim 11, wherein more than half of the gas bubbles in a first layer of the sheet are of open shape, allowing air passage between the gas bubbles of open shape.

17. The article of claim 11, wherein the sheet comprises more than two polymeric layers, wherein each polymeric layer differs with respect to at least one of a ratio of polymer to gas bubble volume or a characteristic size of gas bubbles contained within the layers.

18. The article of claim 11, wherein at least one of the gas bubbles contains a gas other than air.

19. The article of claim 11, wherein at least one of loose fibers or loose particles are embedded within the sheet such that the loose fibers or loose particles are fully submerged in the sheet.

20. The article of claim 11, wherein at least one of loose fibers or loose particles are embedded within an outer part of the sheet such that the loose fibers or loose particles are affixed to the outer part of the sheet and partially protruding out of the sheet.
